(19) United States
(12) Patent Application Publication
(10) Pub. No.: US 2016/0219149 A1
(43) Pub. Date: Jul. 28, 2016

(54) USING SIMULTANEOUS MULTI-CHANNEL FOR CONTINUOUS AND TIMELY FEEDBACK ABOUT AGENT PERFORMANCE DURING A CUSTOMER INTERACTION

(71) Applicant: Avaya Inc., Santa Clara, CA (US)

(72) Inventors: Parameshwaran Krishnan, Basking Ridge, NJ (US); Srinivasa S. Pradeep Nekkalapudi, Waltham, MA (US); Navjot Singh, Somerset, NJ (US)

(21) Appl. No.: 14/620,458

(22) Filed: Feb. 12, 2015

Related U.S. Application Data
(60) Provisional application No. 62/106,517, filed on Jan. 22, 2015.

(51) Int. Cl. H04M 3/51; H04M 3/42

(52) U.S. Cl. CPC H04M 3/5175; H04M 3/42221; H04M 3/5191

(57) ABSTRACT

Obtaining customer feedback is an important tool for a contact center to determine their performance as viewed from those with whom they interact. Customers interacting with an agent over a voice or other channel (e.g., co-browse, text chat, video, etc.) may provide real-time feedback. This real-time feedback may be transmitted to the contact center via a data channel and then utilized to alert a supervisor, trigger the transfer of the call to another agent, training purposes, or other activity. Furthermore, customers' real-time feedback is, “in the moment,” enabling a portion of the agent-customer interaction to be associated with a particular user's feedback input, rather than limiting feedback to a user's patience and memory to evaluate the entire feedback after the interaction has concluded.

### CROSS-REFERENCE TO RELATED APPLICATIONS

The present application claims the benefit of Provisional Patent Application No. 62/106,517, filed on Jan. 22, 2015, and is incorporated herein by reference in its entirety.

### FIELD OF THE DISCLOSURE

The present disclosure is generally directed toward systems to capture and process feedback in a communications system.

### BACKGROUND

Getting feedback from customers about agent performance is typically done by providing the customer with a feedback survey after their call with an agent. Asking for feedback after a call presents several problems, including: (i) the customer may not be inclined to spend additional time to participate in the survey and will usually opt-out and (ii) the delay may cause the customer's emotional state to change compared to the emotional state observed during the customer-agent transaction.

### SUMMARY

It is with respect to the above issues and other problems that the embodiments presented herein were contemplated.

In one embodiment, a contact center receives a notification of a customer sentiment in real-time, or nearly so, to facilitate better customer service. The presence of simultaneous, multi-channel communications facilitates more timely, “in the moment,” fine-grained feedback from the customer during an interaction.

The multiple channels may include a web session (e.g., HTML5) or application-based channel for the feedback, along with at least channel of voice, video, text-chat, etc. to facilitate the customer-agent interaction.

The multiple channels may be established using WebRTC or via the addition of a web session to a call by sending an SMS to a customer comprising a clickable link to initiate the interaction with the contact center.

In one embodiment, a customer calls the contact center. In response, the customer is sent an SMS with a link that may be clicked on at any time during the call. If the customer decides to provide feedback, whether positive or negative, they can click the link whereby they are presented with an interface operable to receive an input to, “tap their feeling”. The taps may be indexed into the call recording and a summary, including a running sentiment based on the taps, which may be analyzed for further action. The contact center may send the customer the link to launch the interface at the beginning of the call or during the call, such as upon a preliminary automated analysis of the conversation discovering a particular sentiment and/or keywords, upon agent request, upon customer request, upon supervisor request, call duration, and/or other triggering events.

The taps by the customer and/or running sentiment analyzer can be used to (i) alert a supervisor, (ii) automatically transfer the customer to another agent, and/or (iii) pre-alert another agent to whom the call is being transferred about the emotional state of the customer. If alerting a supervisor, the supervisor may be provided an annotated media transcript allowing the supervisor to check the conversation before and/or during the period of customer feedback.

The recorded media may be tagged with the customer feedback to be available for more detailed analysis to supplement or replace automated sentiment analyzers, predictors for customer call quality, training, or feedback.

Having a web session provides an easy and user friendly interface in which a customer may provide their feedback.

In one embodiment, a system is disclosed, comprising: a first agent terminal associated with a first agent of a contact center; an annotation module; a network interface; wherein the network interface is configured to establish an interaction channel to facilitate a real-time interaction between the first agent terminal and a customer device operated by a customer; wherein the network interface is further configured to establish a feedback channel to facilitate a real-time feedback communication from the customer device to the annotation module; and wherein the annotation module is configured to annotate the real-time interaction in accord with the feedback input.

In another embodiment, a method is disclosed, comprising: receiving a real-time interaction between a first agent of a contact center and a customer over an interaction channel of a network; receiving a real-time feedback input from the customer over a feedback channel of the network and wherein the feedback channel is different from the interaction channel; and annotating the real-time interaction with indicia of the feedback input.

In another embodiment, a non-transitory computer readable medium is disclosed with instructions thereon that when read by a computer cause the computer to perform: receiving a real-time interaction between a first agent of a contact center and a customer over an interaction channel of a network; receiving a real-time feedback input from the customer over a feedback channel of the network and wherein the feedback channel is different from the interaction channel; and annotating the real-time interaction with indicia of the feedback input.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a diagram in accordance with embodiments of the present disclosure;

FIG. 3 depicts a customer device in accordance with embodiments of the present disclosure; and

FIG. 4 depicts a process in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Any reference in the description comprising an element number, without a subelement identifier when a subelement identifiers exist in the figures, when used in the plural is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

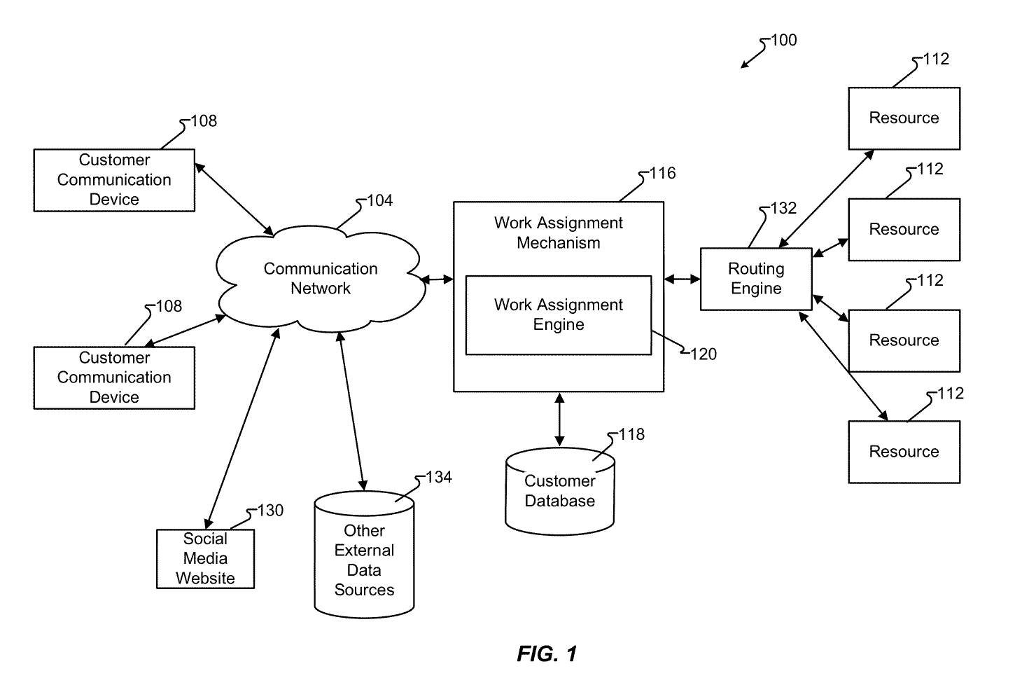

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 and/or other external data sources 134 may be utilized to provide one means for a resource 112 to receive and/or retrieve contacts and connect to a customer of a contact center. Other external data sources 134 may include data sources, such as service bureaus, third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which is hereby incorporated herein by reference in its entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to the contact center. Customer database 118 may be updated in response to a work item and/or input from resource 112 processing the work item.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

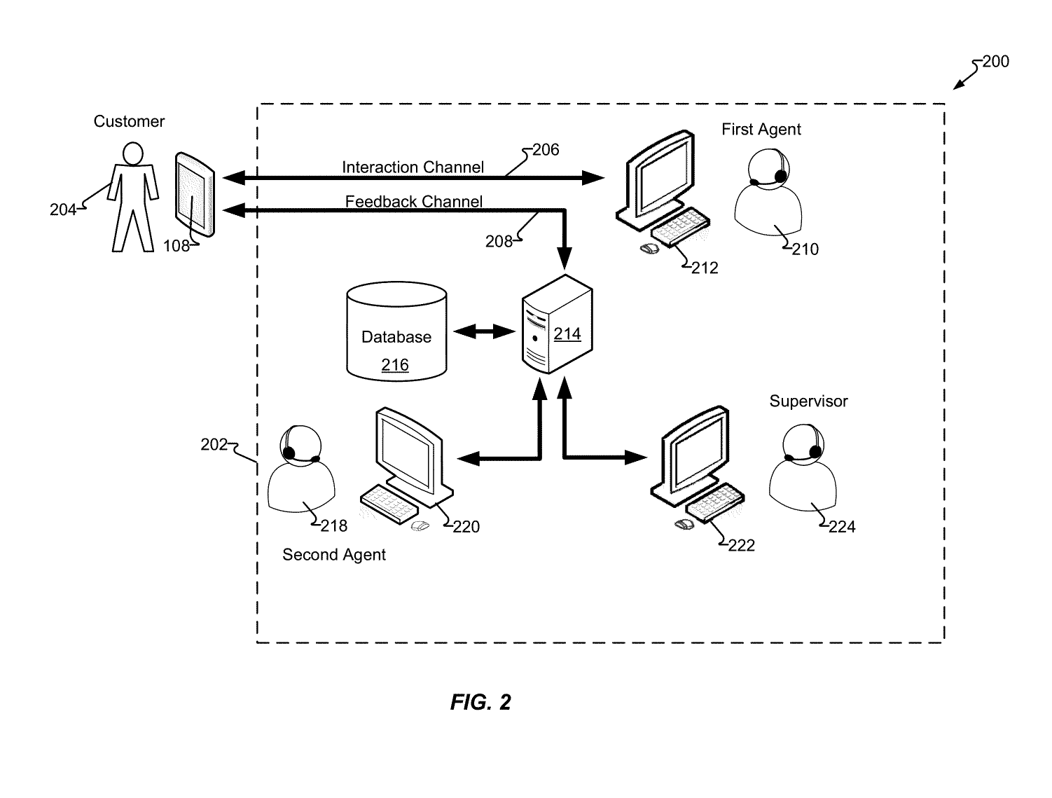

FIG. 2 depicts diagram 200 in accordance with embodiments of the present disclosure. In one embodiment, customer 204 is in communication with contact center 202. Contact center 202 may comprise various components provided with respect to FIG. 1, such as first agent 210, second agent 218, or supervisor 224, each being a resource 112. Contact center 202 omits other components, and/or integrates therewith, of FIG. 1 to avoid unnecessarily complicating the current figure.

In one embodiment, customer 204, utilizes customer device 108, to contact first agent 210 via first agent terminal 212. In other embodiments, first agent 210, or a component acting on behalf of first agent 210, is the initiator of the contact with customer 204. First agent terminal 212 may be any device operable to communicate with customer device 108, such as a POTS telephone, VoIP telephone, computer, tablet, smartphone, etc. Interaction channel 206 is then established between customer 204 and first agent 210 to facilitate the purpose of the interaction (e.g., market a good or service, purchase a good or service, make an inquiry, etc.). Feedback channel 208 may be established before or after the establishment of interaction channel 206.

In another embodiment, server 214 executes certain software modules and/or hardware components. Server 214 may be a component operating other processes, such as routing engine 132. Server 214 may be a plurality of processors, servers, blades, and/or other processing components. Additionally, server 214 may utilize internal memory and/or external memory, such as database 216 for the storage of executable code and/or data.

The interaction on interaction channel 206 may be any real-time communication, such as voice, text, co-browse, and video. During the interaction, customer 204 may be provided with a means, such as an application executing on customer device 108 in which to input real-time feedback regarding the interaction with first agent 210. Feedback may be generic, such as an overall like, dislike, or neutral or specific, such as a rating for a specific aspect of the interaction (e.g., agent helpfulness, understandability, attention to detail, voice connection clarity, etc.). Feedback may be a simple scale (e.g., like/approve/acceptable versus dislike/disapprove/not acceptable) or a more detailed scale (e.g., enthusiastic like, strongly like, somewhat like, neutral, dislike, somewhat dislike, strongly dislike, hate, etc.). The feedback may comprise a default value (e.g., neutral, 3 on a 1-5 scale, etc.). The feedback may be set-unless-changed, such as when a default value is initially set and, upon receiving an input from customer 204, remains at a value in accord with the input until changed by the user or until the interaction concludes. Alternatively, the feedback input may be associated with a particular point in time of the interaction.

As can be appreciated by one of ordinary skill in the art, certain advantages may be obtained by allowing customer 204 to provide real-time input with or without first agent 210 being aware of such input. In one embodiment, customer 204 is the sole determining factor as to a feedback value. For example, a negative feedback may be associated with a degradation of the voice connection quality between customer 204 and first agent 210. In another example, the action of first agent 210 is the subject of the feedback input. In another example, the message delivered by first agent 210 may be the subject of the feedback, such as when customer 204 received a minor inconvenience but is calling to demand a disproportionally generous compensation (e.g., “I had to wait 20 minutes for my luggage. You owe me a free first-class, round trip ticket.”). Whether justified in the minds of others may be a matter of opinion, however, another party may be notified of the feedback, especially negative feedback, and take action if appropriate.

Generally, a neutral or positive feedback input from customer 204 is an indication that all is working as it should. Accordingly, first agent 210 is allowed to process the interaction with customer 204 in the normal course of business. Therefore, the embodiments herein are primarily directed to situations in which one or more feedback inputs are negative and the responses to those negative feedback inputs. However, it should be appreciated that, as a matter of design choice, actions taken upon receiving a negative feedback inputs may be applied to a positive feedback inputs as well.

In one embodiment, server 214 executes an annotation module. The annotation module receives the feedback input via feedback channel 208 and annotates the interaction received via interaction channel 206. Another agent, such as supervisor 224, may be listening to the real-time interaction on interaction channel 206 and be provided with audio, visual, and/or tactile inputs associated with the feedback inputs.

In another embodiment, server 214 executes a recording module. The recording module records the interaction on interaction channel 206 and embeds the interaction within the recording and/or separately annotates the recording with indicia of the feedback input. For example, the recording may be encoded with indicia of the feedback input, such as an icon, label, or other indicator. In another example, a record is created with an entry indexing the associated recorded interaction file or portion associated with the specific feedback input.

In another embodiment, server 214 may determine a feedback input, alone or in conjunction with a number of prior feedback inputs for a particular interaction, a particular agent, and/or other category, has reached a previously determined threshold. For example, three negative feedback inputs during a single interaction, fifteen negative feedback inputs during an agent's work shift; fifty negative feedback inputs from all agents associated with a new upsell campaign, etc. Additional thresholds may be determined in accord with the type and/or granularity of the feedback input provided by customer device 108. For example, one negative input related to telephonic clarity may be beyond a threshold value. In another example, a scale of one to ten is utilized and once an above threshold value is obtained, whether it be with a high number of low values, a low number of high values, or some other mathematical equivalent, action is taken. The specific action taken may be selected as a matter of design choice.

In one embodiment, upon one or more feedback inputs reaching a threshold, server 214 executes a call re-routing module. For example, first agent 210 may be a novice with regard to a particular subject for which customer 204 is inquiring. Should the feedback input received via feedback channel 208 become unacceptable, second agent 218, such as a more skilled agent, may be automatically brought onto the interaction. Upon another agent and/or supervisor being brought into the interaction with customer 204, first agent 210 may remain with the interaction or be dropped, such as to allow first agent 210 to attend to another customer.

In another embodiment, supervisor 224 may be brought onto the interaction. Supervisor 224 may be brought on via supervisor terminal 222 in a mode determined by the supervisor or determined by a process of server 214. For example, supervisor 224 may wish to communicate solely with first agent 210 (e.g., whisper mode) and thereby cause supervisor terminal 222 to allow supervisor 224 to hear both first agent 210 and customer 204 but only be heard by first agent 210. In another embodiment, supervisor 224 may be brought onto the call, such as when customer 204 is identified as having a particular need that requires supervisor 224 (e.g., a purchase above a certain amount, a “gold” level customer, etc.).

The inclusion of another agent (e.g., second agent 218 and/or supervisor 224) may be prompted by a display or signal from their respective terminals (e.g., second agent terminal 220 and/or supervisor terminal 222, respectively). For example, indicia of the feedback that caused, or contributed towards, the agent being notified of the interaction may be presented to the other agent. In one embodiment, a feedback indicia is provided that prompts the other agent to make an input upon their terminal associated with the indicia and be presented with a recording of the interaction. In one embodiment, the portion of the interaction selected for playback includes a prior portion, such as to facilitate the other agent observing the interaction that led to the particular feedback input. This may include a fixed value, a user-determined value, or a dynamic value. A dynamic value may be determined in accord with other systems. For example, if a negative feedback input was received at 2:06 (two minutes, six seconds) for a particular interaction, an automated speech-to-text system may determine that the term “lost luggage” was being discussed. The portion of the recorded feedback may then begin at the first occurrence of the term or similar term. The other agent may be provided with the ability to skip, scan, or otherwise inspect portions of the recording at their discretion.

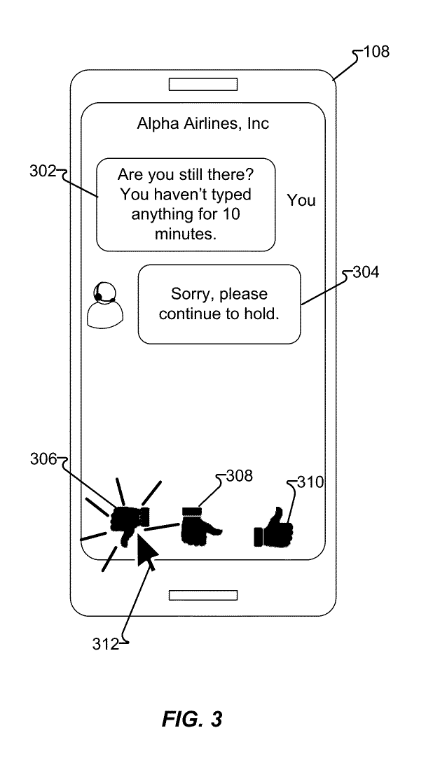

FIG. 3 depicts customer device 108 in accordance with embodiments of the present disclosure. In one embodiment, customer device 108 is configured to establish a text-based real-time interaction with first agent terminal 212. In other embodiments, customer device 108 is configured to exchange other real-time interactions (e.g., voice, video, co-browse, etc.). Message 302 is provided by customer 204. First agent 210 provides response 304. The interaction is maintained via an interaction channel. A feedback channel may be launched concurrently with the interaction channel or at a later time, such as upon receiving a first feedback input on customer device 108. The feedback channel may be fed feedback inputs, such as by a web session or other means, whereby the feedback is discrete from the interaction.

In accord with the response, or other motivation by customer 204, customer 204 is presented with “thumbs down” icon 306, neutral icon 308, and “thumbs up” icon 310. For purposes of clarity, the selection is indicated by pointer icon 312. Other inputs may be received via other input interfaces (e.g., slider, checkbox, number, touch, etc.), which may be further determined by the mode in which interaction channel 206 is operating. For example, a voice call may utilize phone buttons to provide DTMF tones as the feedback input.

The feedback is then transmitted to the contact center, such as to server 214, for annotation of the interaction and, if determined appropriate, a response action. Certain advantages may be provided by allowing customer 204 to provide input without first agent 210 becoming aware of the input. Certain customers 204 may be reluctant to provide feedback directly to first agent 210. By providing a separate channel, customer 204 may still express their views on the interaction in real-time and without interrupting the interaction with first agent 210. Similarly, first agent 210 may find it distracting to become aware of feedback, especially negative feedback, and further strain the interaction. Still, contact center 202 may wish to have a record of the interaction and having annotations of the feedback may further benefit training, evaluation, as well as mitigation by second agent 218 and/or supervisor 224. As a benefit, contact center 202 and/or first agent 210 may improve operations and provide a better experience for further customers.

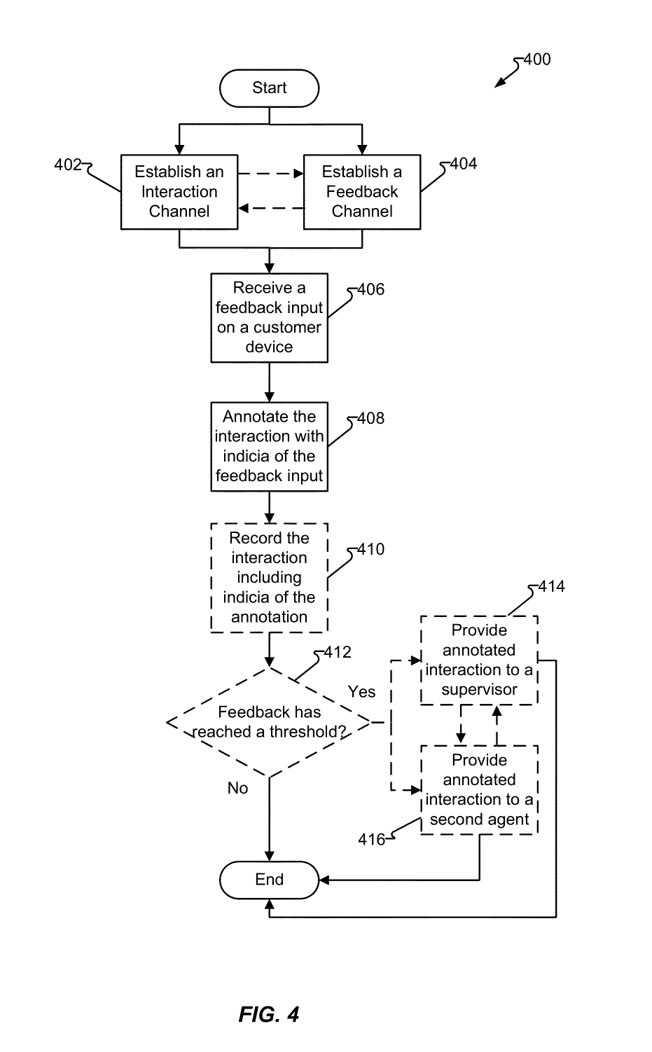

FIG. 4 depicts process 400 in accordance with embodiments of the present disclosure. In one embodiment, process 400 begins with step 402 establishing interaction channel 206 between customer 204 utilizing customer device 108 and first agent 210 utilizing first agent terminal 212. Concurrently, or nearly so, step 404 establishes a feedback channel between customer device 108 and server 214, such as by establishing a web session or other channel of communication separate from the content interaction channel 206. In another embodiment, step 404 is first and then proceeds to step 402 and in yet another embodiment, step 402 is first and proceeds to step 404. Once step 402 and 404 have completed, processing continues to step 406.

In one embodiment, step 406 comprises customer 204 inputting a feedback upon customer device 108 while engaged in a real-time interaction with agent 210. The feedback input is transmitted to server 214 via feedback channel 208. In another embodiment, customer 204 may utilize separate customer devices 108. One customer device 108 is utilized for communication with first agent 210 via interaction channel 206 and another customer device 108 is utilized for receiving the inputs from customer 204 and providing the feedback inputs to server 214 via feedback channel 208.

Next, step 408 annotates the interaction between customer 204 and first agent 210, such as by executing an annotation component or module of server 214. In one embodiment, process 400 terminates following step 408, such as when supervisor 224 is observing the annotated interaction in real-time. Optionally, step 410 records the annotated interaction for playback at a later time. The later time may be shortly after the feedback input was received, and the interaction is still ongoing, or after the interaction has concluded, such as to facilitate review and training.

In another embodiment, step 412 evaluates the feedback input to determine if further action is required. For example, step 412 determines that an interaction has received an unacceptable number of negative feedback inputs, processing may continue to step 414 and/or step 416. However, if step 412 determines that no further action is required, process 400 may terminate.

In one embodiment, step 414 is executed. A signal associated with the annotated interaction provided to supervisor 224 via supervisor terminal 222, such as an audio tone, visual indicator (e.g., icon, color-change, etc.), and/or textual (e.g., SMS, email, pop-up message, status message, etc.). Supervisor 414 may then review the annotated interaction, such as by selecting an icon associated with a particular feedback input. Server 214 and/or other component of contact center 202 may then play back a portion of the interaction (e.g., an audio recording comprising the ninety seconds ending with a negative feedback input, etc.). Supervisor 414 may then take action as determined appropriate, such as taking over the interaction, providing “whisper” instructions to agent 210, initiating a transfer to second agent 218, etc.

In another embodiment, step 416 is executed. Step 416 may be executed by server 214, which may automatically initiate the inclusion of second agent 218 or indicate a suggestion to include second agent 218 that is initiated upon approval, such as by supervisor 224, second agent 218, customer 204, and/or other party. Step 416 may be executed following step 412, which will determine whether there is a need to take an action, and will be performed instead of step 414, following step 414, prior to step 414, or concurrently with step 414. Optionally, step 416 may continue to include first agent 210 or discontinue the interaction with first agent 210. Upon the completion of the selected one or both of steps 414 and 416, process 400 terminates. However, in a further embodiment, once second agent 218 is included in the interaction, process 400 may continue back at step 406 whereby second agent 218 is now first agent 210. If the original first agent 210 remains on the call, both agents may be considered first agents 210 for further processing by process 400.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A system, comprising:
a first agent terminal associated with a first agent of a contact center;
an annotation module;
a network interface;
wherein the network interface is configured to establish an interaction channel to facilitate a real-time interaction between the first agent terminal and a customer device operated by a customer;
wherein the network interface is further configured to establish a feedback channel to facilitate a real-time feedback communication from the customer device to the annotation module, wherein the feedback channel is created in response to the customer device accessing a Uniform Resource Locator (URL) of a web page operable to receive a feedback input to the feedback channel; and
wherein the annotation module is configured to annotate the real-time interaction in accord with the feedback input.

2. The system of claim 1, wherein:
the feedback input comprises a plurality of feedback inputs;
a second agent terminal associated with a second agent different from the first agent; and
an interaction assignment module configured to automatically initiate the incorporation of the second agent, utilizing the second agent terminal, into the interaction channel upon determining at least one of the plurality of feedback inputs has reached a previously determined threshold.

3. The system of claim 2, further comprising:
a recording module configured to record the real-time interaction; and
wherein the recording module is operable to receive a selection associated with a portion of the recorded real-time interaction and cause a playback of a portion of the real-time interaction in accord with the selection.

4. The system of claim 3, wherein the selection is associated with an indicia of the feedback input and the playback portion of the real-time interaction comprises a portion of the real-time interaction associated with the feedback input.

5. The system of claim 1, further comprising:
a supervisor terminal;
alerting module;
wherein the feedback input comprises a plurality of feedback inputs; and
wherein the alerting module is configured to receive the feedback input and, upon at least one of the plurality of the feedback inputs has reached a previously determined threshold, signaling the supervisor terminal in accord with the at least one of the plurality of feedback inputs.

6. The system of claim 1, further comprising:
a reporting module;
a supervisor terminal configured to execute the reporting module; and
wherein the reporting module is operable to present indicia of the feedback input to an operator of the supervisor terminal.

7. The system of claim 6, wherein the reporting module is operable to present indicia of the feedback input and indicia of the interaction.

8. The system of claim 7, further comprising:
a recording module configured to record the real-time interaction; and
wherein the reporting module is operable to receive a selection associated with a portion of the recorded real-time interaction and cause a playback of the portion of the real-time interaction in accord with the selection.

9. The system of claim 1, further comprising:
a data channel; and
wherein the data channel comprises the feedback channel and the interaction channel.

10. The system of claim 1, wherein the feedback channel comprises a web session.

11. A method, comprising:
receiving, at a server, a real-time interaction between a first agent of a contact center and a customer over an interaction channel of a network;
receiving, at the server, a real-time feedback input from the customer over a feedback channel of the network and wherein the feedback channel is different from the interaction channel and wherein the real-time feedback input is associated with an indicia comprising a topic; and
annotating the real-time interaction with indicia of the feedback input, the annotation comprising a point in time for a received real-time feedback input.

12. The method of claim 11, further comprising:
wherein the feedback input comprises a number of feedback inputs and determining at least one of the feedback inputs has reached a previously defined threshold; and
in response to the determining step, automatically initiating, by the server, the incorporation of a second agent into the interaction.

13. The method of claim 12, further comprising:
receiving, by the server, an input from the second agent, the input being associated with an indicia of the feedback input; and
in response to the received input, causing, by the server, a playback of a portion of the recorded interaction to be presented to the second agent, the portion being selected in accord with the indicia.

14. The method of claim 11, further comprising:
wherein the feedback input comprises a plurality of feedback inputs and, upon an aggregation of the plurality of feedback inputs reaching a previously determined threshold, signaling a supervisor terminal in accord with the aggregation.

15. The method of claim 14, further comprising,
presenting, by the server, indicia of the feedback input to an operator of the supervisor terminal;
presenting, by the server, indicia of the interaction at a time substantially concurrent to a time in which the feedback input was received; and
upon receiving an input upon the supervisor terminal associated with the indicia of the feedback input, playing back, by the server, a portion of the recording of the interaction associated with the feedback input.

16. A system comprising:
means to receive, by a server, a real-time interaction between a first agent of a contact center and a customer over an interaction channel of a network;
means to receive, by the server, a real-time feedback input from the customer over a feedback channel of the network and wherein the feedback channel is different from the interaction channel and wherein the real-time feedback is associated with an indicia comprising a topic; and
means to annotate, by the server, the real-time interaction with the indicia of the feedback input.

17. The system of claim 16, wherein:
the feedback input comprises a number of feedback inputs and determining at least one of the feedback inputs has reached a previously defined threshold; and
in response to the determining step, means to automatically initiate, by the server, the incorporation of a second agent into the interaction.

18. The system of claim 17, further comprising:
means to receive, by the server, an input from the second agent, the input being associated with the indicia of the feedback input; and
in response to the received input, means to cause, by the server, a playback of a portion of the recorded interaction to be presented to the second agent, the portion being selected in accord with the indicia.

19. The system of claim 16, wherein:
the feedback input comprises a plurality of feedback inputs and, upon an aggregation of the plurality of feedback inputs reaching a previously determined threshold, means to signal, by the server, a supervisor terminal in accord with the aggregation.

20. The system of claim 19, further comprising:
means to present, by the server, the indicia of the feedback input to an operator of the supervisor terminal;
means to present, by the server, the indicia of the interaction at a time substantially concurrent to a time in which the feedback input was received; and
upon receiving an input upon the supervisor terminal associated with the indicia of the feedback input, means to play back, by the server, a portion of the recording of the interaction associated with the feedback input.
